(19) United States
(12) Patent Application Publication
(10) Pub. No.: US 2010/0314564 A1
(43) Pub. Date: Dec. 16, 2010

(54) Apparatus with movable timing sleeve control of flow through, and safety control operation

(76) Inventor: Herbert W. Hoeptner, III, Gilroy, CA (US)

Correspondence Address: WILLIAM W. HAEFLIGER, 201 S. LAKE AVE, SUITE 512, PASADENA, CA, 91101, US

(21) Appl. No.: 12/456,236

(22) Filed: Jun. 15, 2009

(51) Int. Cl. F16K 21/04

(52) U.S. Cl. 251/15

(57) ABSTRACT

Fluid flow control apparatus, comprising a tubular body, a spool within the body, and a timer sleeve movable axially in the body and relative to the spool, to control fluid flow through the spool in response to fluid pressure applied to a closed end of the sleeve; a seat extending within the body to be engaged by the open end of the sleeve, thereby to effect stoppage of flow through the spool, in a flow blocking axial position of the sleeve; and means including a stem extending axially within the spool to define therewith a leakage path for fluid to slowly leak form within the timer sleeve to the downstream exterior of the spool.

This invention relates generally to fluid pressure controlled valves, and more particularly to improvements in such valves that incorporate axially movable timer sleeves, as for example in U.S. Pat. Nos. 6,408,870 and 6,644,345.

### BACKGROUND OF THE INVENTION

There is need for improvements in the control of such valves, and particularly in regard to bleed responsive operation of such valves. For example, there is need for simplification and more effective operation of elements in such valves, to provide safety in control of fluid flow, as to appliances.

### SUMMARY OF THE INVENTION

It is a major object of the invention to provide improvements meeting the above needs. Basically, the invention incorporates, in flow control apparatus:

a) a tubular body, a spool within the body, and a timer sleeve movable axially in the body and relative to the spool, to control fluid flow through the spool in response to fluid pressure applied to a closed end of the sleeve,

b) a seat extending within the body to be engaged by the open end of the sleeve, thereby to effect stoppage of flow through the spool, in a flow blocking axial position of the sleeve,

c) and means including a stem extending axially within the spool to define therewith a leakage path for fluid to slowly leak from within the timer sleeve to the downstream exterior of the spool.

Another object is to provide a spool bore receiving the stem, the stem and bore having loose interfit along the stem length, to enable and to control such slow leakage.

A further object is to provide the spool with a through port or ports via which fluid flows toward said downstream exterior prior to engagement of the sleeve open end with the seat. Typically, the spool also defines a flow path communicating axially with the through port, substantially radially inwardly of the seat.

An added object is to provide a spring located between the spool and the closed end of the timer sleeve to urge the sleeve in an axial direction away from the leakage enabling stem.

Yet another object is to provide an annular seal within the timer sleeve, and sealing off between the timer sleeve and the spool. That seal typically defines a leakage path enabling slow leakage of fluid past the seal and into a space within the sleeve and adjacent the sleeve closed end. Such path typically has seal peripheral notch configuration. Also, the seal is carried to be axially shiftable between operative positions.

As will be seen the spool typically has first, second and third sections, the first section defining at least one through port via which fluid flows prior to sleeve open end engagement with the seat. In a modification, the stem defines a through bore, and a check valve is located in that bore.

In operation, means is provided to supply fluid to the tubular body to pressurize the closed end of the timer sleeve; and an appliance is typically connected to receive fluid flowing through said body via said port.

As will be understood, an automatically operating safety flow control apparatus is provided by the invention, which resets, automatically.

These and other objects and advantages of the invention, as well as the details of an illustrative embodiment, will be more fully understood from the following specification and drawings, in which:

### DRAWING DESCRIPTION

FIGS. 1-4 show various positions of elements of the preferred apparatus, prior to and during their operation, as will be seen;

FIG. 5 is an exploded view of the apparatus;

FIG. 6 is a perspective view of a leaky stem; and

FIG. 7 shows a modification.

### DETAILED DESCRIPTION

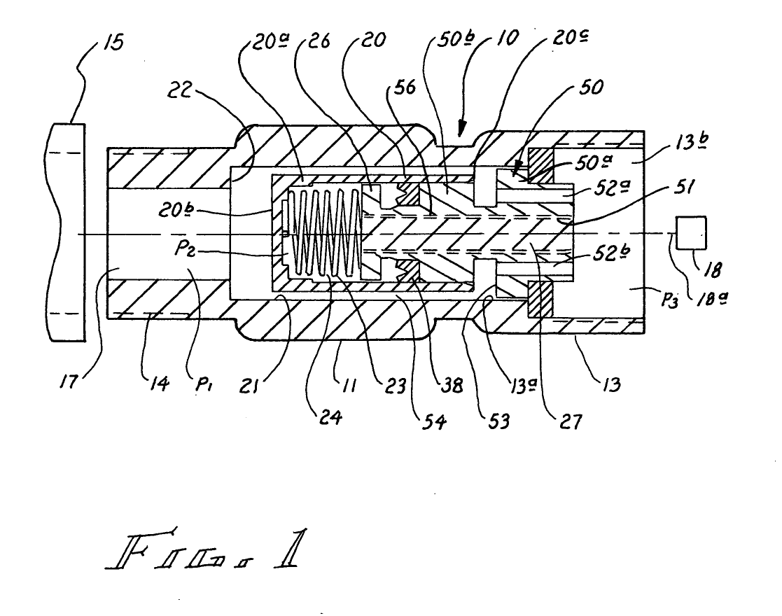

FIG. 1 shows a tubular body 10 that includes a tubular section 11 thereof integral with tubular section 13. Section 11 is threaded at 14 for connection into a supply pipe 15. Pressurized water entrance is indicated at 17. Section 13 has a cylindrical bore 13a, and an enlarged outlet at 13b connectible to downstream appliance 18, such as a toilet, ice-maker, sink, etc. See duct 18a.

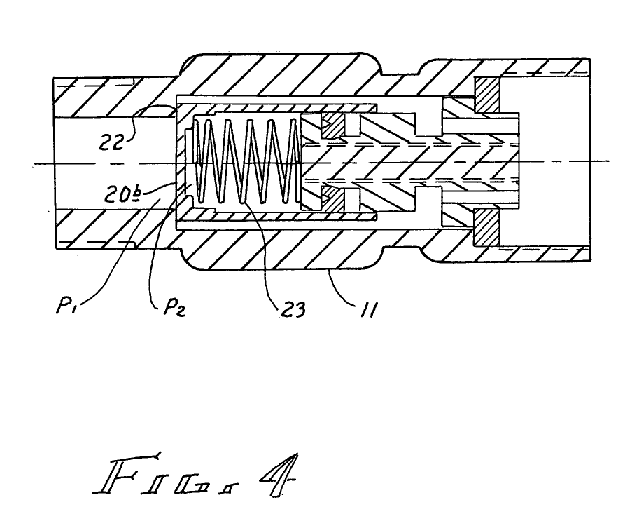

A timer sleeve or cup 20 is axially movable endwise in counterbore 21 of section 11, and includes a side wall 20a and end wall 20b. The opposite end 20c of the sleeve is open. FIG. 4 shows end wall 20b seated against shoulder 22 of body section 11, in the illustrated flow shut-off retracted position of the sleeve. As will be understood, sleeve 20 functions as a piston in response to fluid or water pressure P₁ exertion rightwardly against end wall 20b, water pressure exertion leftwardly at P₂ against wall 20b, and pressure of a helical spring 23 exerted leftwardly against end wall 20b. Spring 23 is confined within the interior clamber 24 of the sleeve.

The rightward end of the spring bears against a tubular flow regulator part 26 to which an axially extending stem 27 is connected. A spool 50 is located within the body 10, and has a bore 51 within which the stem extends. The spool has first and second sections, 50a and 50b, and part 26 may be considered as a third section of the spool. See also seal 40. Section 50a defines at least one, and preferably two through ports 52a and 52b extending parallel to bore 51, and via which pressurized fluid flows prior to sleeve open end 20c engagement with a seat 53. The seat is located to face toward the spool second section 50b, and its rightward engagement by the sleeve end 20c serves to stop fluid flow from 17, then via passage 54 outwardly of the sleeve, and then via through ports 52a and 52b to the outlet region 13b, and to the appliances 18. Elastomer annulus 38 in the body engages the spool and positions it axially in the body 10, as well as providing a seal.

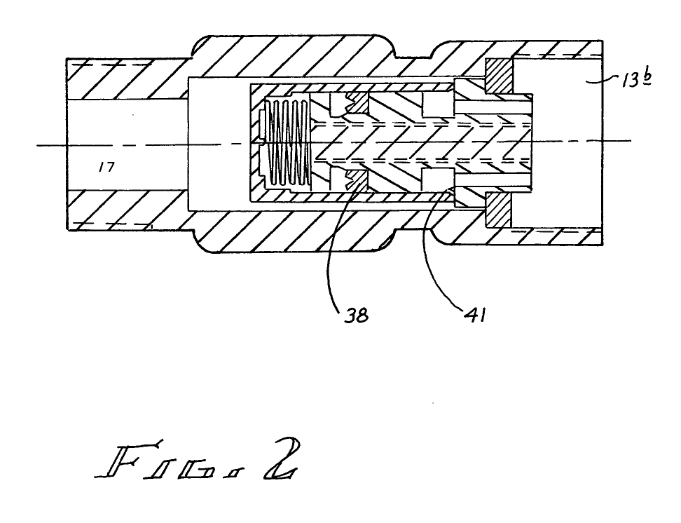

The peripheral fit at 56 of the stem 27 within the spool bore 51 is such as to provide a slow leakage axial path 58 for higher pressure fluid within sleeve interior chamber 24 to leak (for example drip) to exit 13b, releasing pressure at P₂, enabling the sleeve to move rightwardly and seat at 53, arresting flow to the appliance as in the case of appliance failure. This condition is shown in FIG. 2.

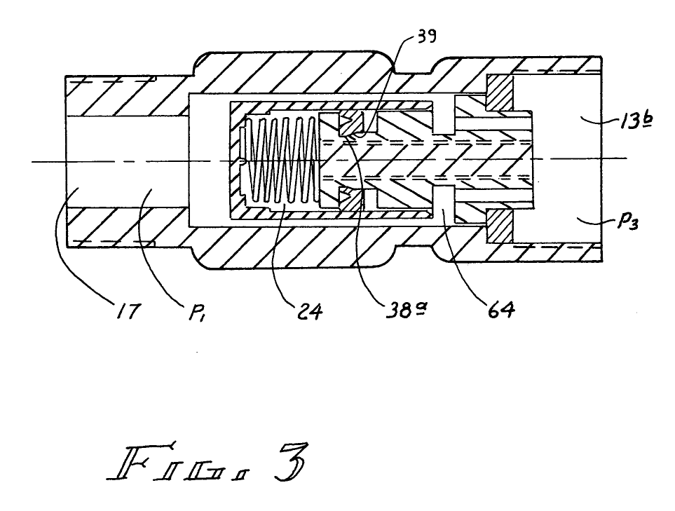

Also provided is annular seal 38 located within the timer sleeve, and sealing off between the sleeve bore and a reduced diameter axial extension 39 of the spool. The seal defines a leakage path, proximate the seal lip 38a, enabling slow leakage or passage of fluid, after the seal has moved bodily to the left, in FIG. 3, over taper on 39. Note back pressure exertion of fluid in discharge zone 13b, back through ports 52a and 52b, and pressure equalization as between 17 and 13b.

The sleeve defines a notch 41 at its open end, also allowing such pressure equalization as between 17 and 13b in FIG. 2.

Note in FIG. 1 that pressure at P₁ is typically 60 psi, when pressure at P₃ in 13b, is the same as P₁ a downstream valve as at an appliance 18 being open. The sleeve or cup may move slowly to the right. Ports 52a and 52b are open.

In FIG. 2 the timer sleeve or cup has moved to the right, to seat at 53 and close off flow to downstream, whereby the appliance does not overflow, preventing flooding of a house, for example. Notch 41 enables equalization of pressure, by allowing only drip through ports 52a and 52b.

In FIG. 3, the downstream valve has been repaired, and is closed (toilet valve fixed or hose replaced), and back pressure at P₃, equaling P₁ pressure, is exerted at 64; the spring displaces the sleeve to the left, and fluid enters chamber 24 after by-passing the displaced seal 38.

In FIG. 4, the closed end of the sleeve or timer cup has seated against shoulder 22 in response to spring pressure. This is a self reset condition.

A dual adjustment of flow through volume is achieved. One way is by increasing or decreasing the resistance imposed by resistance to flow at stem—spool interface at 39. Another way is by increasing or decreasing the number of ports 52 in the spool, only two ports 52a and 52b being shown in FIG. 1.

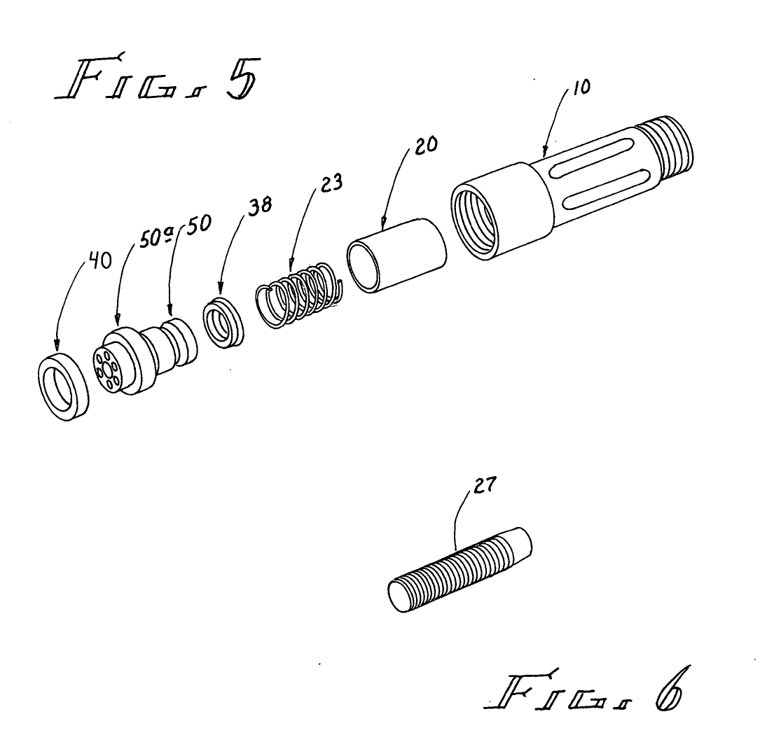

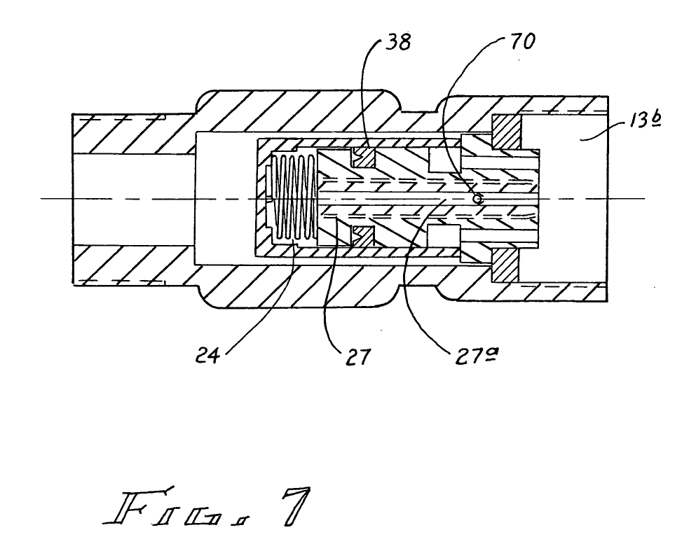

FIG. 5 shows the components of the apparatus in telescopically exploded arrangement; and FIG. 6 is a perspective view of the stem 27, showing its irregular or roughened surface, including slow leakage as referred to.

FIG. 7 shows a modified form of the invention, in which the stem 27 defines a through bore 27a communicating with 13b and 24, with a check valve 70 in that bore to pass fluid in direction 71, but not reversely. The annular seal 38 does not move leftwardly off spool axial extension 39 during operation.

What is claimed is:

1. Fluid flow control apparatus, comprising, in combination:
a) a tubular body, a spool within the body, and a timer sleeve movable axially in the body and relative to the spool, to control fluid flow through the spool in response to fluid pressure applied to a closed end of the sleeve,
b) a seat extending within the body to be engaged by the open end of the sleeve, thereby to effect stoppage of flow through the spool, in a flow blocking axial position of the sleeve,
c) and means including a stem extending axially within the spool to define therewith a leakage path for fluid to slowly leak from within the timer sleeve to the downstream exterior of the spool.

2. The combination of claim 1 wherein the spool defines a bore receiving the stem, the stem and bore having leaking interfit along the stem length.

3. The combination of claim 1 wherein the spool defines a through port via which fluid flows toward said downstream exterior prior to engagement of the sleeve open end with said seat.

4. The combination of claim 3 wherein the spool defines a flow path communicating axially with said through port, substantially radially inwardly of the seat.

5. The combination of claim 1 including a spring located between the spool and said closed end of the timer sleeve to urge the sleeve in an axial direction away from said leakage enabling stem.

6. The combination of claim 1 including an annular seal within the timer sleeve, and sealing off between the timer sleeve and the spool.

7. The combination of claim 6 wherein the seal defines a leakage path enabling slow leakage of fluid past the seal and into a space within the sleeve and adjacent said sleeve closed end.

8. The combination of claim 7 wherein said sleeve defines a notch at its open end for pressure equalization.

9. The combination of claim 7 wherein the seal is carried to be axially shiftable between positions in one of which said slow leakage is enabled.

10. The combination of claim 7 wherein the spool has first and second sections, the first section defining at least one through port via which fluid flows prior to sleeve open end engagement with the seat, and the seat located to face the second section.

11. The combination of claim 1 including means supplying fluid to said tubular body to pressurize said closed end of the timer sleeve.

12. The combination of claim 11 including an appliance connected to receive fluid flowing through said body via said port.

13. The combination of claim 1 wherein the stem defines an axial through path for fluid flow between said downstream exterior and the interior of the timer sleeve, there being a check valve in said through path.
